(19) United States
(12) Patent Application Publication
(10) Pub. No.: US 2025/0298830 A1
(43) Pub. Date: Sep. 25, 2025

(54) INFORMATION PROCESSING APPARATUS, INFORMATION PROCESSING METHOD, AND NON-TRANSITORY COMPUTER-READABLE RECORDING MEDIUM

(71) Applicant: LY Corporation, Tokyo (JP)

(72) Inventor: Takashi YAMADA, Tokyo (JP)

(21) Appl. No.: 19/044,252

(22) Filed: Feb. 3, 2025

(30) Foreign Application Priority Data
Mar. 19, 2024 (JP) 2024-043697

(51) Int. Cl. G06F 16/34

(52) U.S. Cl. CPC G06F 16/345

(57) ABSTRACT

An information processing apparatus according to the present application includes a generation unit, an extraction unit, and a provision unit. The generation unit generates, based on a comment summary serving as a summary of a plurality of comments generated based on a plurality of comments on a content related to one event, the content being provided on a predetermined service, an integrated summary for the one event for each predetermined time period. The extraction unit extracts, based on a first integrated summary generated by the generation unit during a first time period and a second integrated summary generated by the generation unit during a second time period, a difference point between the first integrated summary and the second integrated summary and a reason related to the difference point. The provision unit provides information on the difference point and the reason to a user using the predetermined service.

### CROSS-REFERENCE TO RELATED APPLICATIONS

The present application claims priority to and incorporates by reference the entire contents of Japanese Patent Application No. 2024-043697 filed in Japan on Mar. 19, 2024.

### BACKGROUND OF THE INVENTION

### 1. Field of the Invention

The present invention relates to an information processing apparatus, an information processing method, and a non-transitory computer-readable recording medium.

### 2. Description of the Related Art

Conventionally, there is known a technique of providing a comment posted by a user on a news article to another user who has browsed the news article.

However, in the above-described conventional technique, since the comment posted by the user on the news article is merely provided to other users who have browsed the news article, there is room for improvement in terms of providing useful information on the comment.

### SUMMARY OF THE INVENTION

It is an object of the present invention to at least partially solve the problems in the conventional technology.

According to an example of a subject matter described in a present disclosure, an information processing apparatus includes a generation unit configured to generate, based on a comment summary serving as a summary of a plurality of comments generated based on a plurality of comments on a content related to one event, the content being provided on a predetermined service, an integrated summary for the one event for each predetermined time period, an extraction unit configured to extract, based on a first integrated summary generated by the generation unit during a first time period and a second integrated summary generated by the generation unit during a second time period, a difference point between the first integrated summary and the second integrated summary and a reason related to the difference point, and a provision unit configured to provide information on the difference point and the reason to a user using the predetermined service.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of provision processing executed by an information processing apparatus according to an embodiment;

FIG. 2 is a diagram illustrating a configuration example of an information processing system according to the embodiment;

FIG. 3 is a diagram illustrating an example of a user information storage unit according to the embodiment;

FIG. 4 is a diagram illustrating an example of an integrated summary information storage unit according to the embodiment;

FIG. 5 is a diagram illustrating an example of a difference point information storage unit according to the embodiment;

FIG. 6 is a flowchart illustrating an example of a flow of generation processing executed by the information processing apparatus according to the embodiment;

FIG. 7 is a flowchart illustrating an example of a flow of the provision processing executed by the information processing apparatus according to the embodiment; and

FIG. 8 is a hardware configuration diagram illustrating an example of a computer configured to implement a function of the information processing apparatus.

### DETAILED DESCRIPTION OF THE PREFERRED EMBODIMENTS

Hereinafter, a detailed description will be given as to a mode (hereinafter, referred to as an “embodiment”) for executing an information processing apparatus, an information processing method, and a non-transitory computer-readable recording medium according to the present application with reference to the drawings. It is noted that the information processing apparatus, the information processing method, and the non-transitory computer-readable recording medium according to the present application are not limited by the embodiment. In addition, the respective embodiments can be appropriately combined with each other within a range in which processing contents do not contradict each other. In the following embodiments, the same parts will be denoted by the same reference numerals, and a redundant description thereof will be omitted.

### [1. Example of Provision Processing Executed by Information Processing Apparatus]

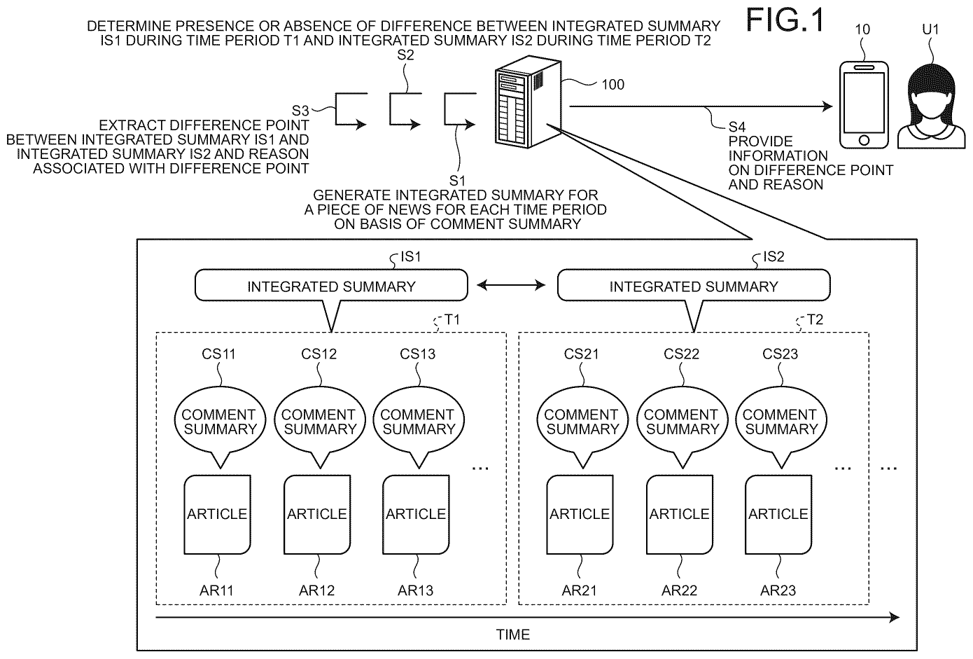

The provision processing executed by an information processing apparatus 100 will be described with reference to FIG. 1. FIG. 1 is a diagram illustrating an example of the provision processing executed by the information processing apparatus 100 according to the embodiment.

First, assumption will be described. In the example of FIG. 1, it is assumed that a user U1 has installed a news providing application A in advance on a terminal apparatus 10 to be used by the user U1 himself or herself as an example of a predetermined news providing service (an example of a predetermined service). In the example of FIG. 1, it is assumed that the user U1 uses the news providing application A. In this case, the terminal apparatus 10 displays an article as a content on the news providing application A.

In the example of FIG. 1, it is assumed that a plurality of articles AR11 to AR23 related to a piece of news are provided as one event. For example, the user posts a comment on each of the articles AR11 to AR13 provided during a time period T1 (an example of a first time period). In the example of FIG. 1, a plurality of users post a plurality of comments on the article AR11. Furthermore, a plurality of users post a plurality of comments on the article AR12. Furthermore, a plurality of users post a plurality of comments on the article AR13.

In this case, the information processing apparatus 100 generates, based on a plurality of comments on each of the articles, a comment summary serving as a summary of the plurality of comments for each of the articles. In the example of FIG. 1, the information processing apparatus 100 generates a comment summary CS11 for the article AR11. Furthermore, the information processing apparatus 100 generates a comment summary CS12 for the article AR12. Further, the information processing apparatus 100 generates a comment summary CS13 for the article AR13.

Furthermore, it is assumed that the user posts a comment on each of the articles AR21 to AR23 provided during a time period T2 (an example of a second time period). In the example of FIG. 1, a plurality of users post a plurality of comments on the article AR21. Additionally, a plurality of users post a plurality of comments on the article AR22. Furthermore, a plurality of users post a plurality of comments on the article AR23.

In this case, in the example of FIG. 1, the information processing apparatus 100 generates a comment summary CS21 for the article AR21. Additionally, the information processing apparatus 100 generates a comment summary CS22 for the article AR22. Further, the information processing apparatus 100 generates a comment summary CS23 for the article AR23.

Hereinafter, referring to FIG. 1, a description will be given as to an example in which the information processing apparatus 100 generates, based on a plurality of comment summaries, an integrated summary for a piece of news for each time period in such a case.

As illustrated in FIG. 1, the information processing apparatus 100 generates an integrated summary for a piece of news for each time period on the basis of the comment summary (Step S1). For example, the information processing apparatus 100 generates an integrated summary for a piece of news at a predetermined timing, in which the integrated summary is provided during a predetermined time period.

In the example of FIG. 1, the information processing apparatus 100 generates an integrated summary IS1 (an example of a first integrated summary) for a piece of news on the basis of the comment summaries CS11 to CS13 during the time period T1. In this case, when the number of comment summaries having a common content among the comment summaries CS11 to CS13 for the respective articles AR11 to AR13 is equal to or more than a predetermined threshold value, the information processing apparatus 100 generates the integrated summary on the basis of the comment summaries having the common content. As a result, the information processing apparatus 100 can generate the integrated summary on the basis of the tendency of the content of each comment summary.

Furthermore, the information processing apparatus 100 generates an integrated summary IS2 (an example of a second integrated summary) for a piece of news on the basis of the comment summaries CS21 to CS23 during the time period T2.

As a more specific example, it is assumed that a piece of news is news related to an indictment. Furthermore, it is assumed that the tendency of the contents of the comment summaries CS11 to CS13 for the respective articles AR11 to AR13 provided during the time period T1 is a content indicating that “the statement made by the accuser is not reliable”. It is also assumed that the tendency of the contents of the comment summaries CS21 to CS23 for the respective articles AR21 to AR23 provided during the time period T2 is a content indicating that “a plurality of contents similar to the accused contents are testified. The defense of the accused party is weakening”. In this case, the information processing apparatus 100 generates, as the integrated summary IS1, an integrated summary stating that “the statement made by the accuser is not reliable” on the basis of the comment summaries CS11 to CS13 for the respective articles AR11 to AR13 provided during the time period T1. Furthermore, the information processing apparatus 100 generates, as the integrated summary IS2, an integrated summary stating that “a plurality of contents similar to the accused contents are testified. The defense of the accused party is weakening” on the basis of the comment summaries CS21 to CS23 for the respective articles AR21 to AR23 during the time period T2.

Then, the information processing apparatus 100 determines whether there is a difference between the integrated summary IS1 during the time period T1 and the integrated summary IS2 during the time period T2 (Step S2). For example, upon determining that the difference between the integrated summary IS1 during the time period T1 and the integrated summary IS2 during the time period T2 is equal to or greater than a predetermined threshold value, the information processing apparatus 100 determines that there is the difference between the integrated summary IS1 during the time period T1 and the integrated summary IS2 during the time period T2.

On the other hand, upon determining that the difference between the integrated summary IS1 during the time period T1 and the integrated summary IS2 during the time period T2 is less than the predetermined threshold value, the information processing apparatus 100 determines that there is no difference between the integrated summary IS1 during the time period T1 and the integrated summary IS2 during the time period T2.

As a more specific example, it is assumed that the integrated summary IS1 during the time period T1 is “the statement made by the accuser is not reliable”. It is also assumed that the integrated summary IS2 during the time period T2 is “a plurality of contents similar to the accused contents are testified. The defense of the accused party is weakening”. In this case, the information processing apparatus 100 uses a conventional technique such as a natural language processing technique to determine the difference between the integrated summary IS1 during the time period T1 and the integrated summary IS2 during the time period T2. At this time, the information processing apparatus 100 compares the integrated summary IS1 stating that “the statement made by the accused party is not reliable” with the integrated summary IS2 stating that “a plurality of contents similar to the accused contents are testified. The defense of the accused party is weakening” and determines that there is the difference between the integrated summary IS1 and the integrated summary IS2. In the example of FIG. 1, a description will be given below assuming that there is the difference between the integrated summary IS1 and the integrated summary IS2.

Subsequently, the information processing apparatus 100 extracts a difference point between the integrated summary IS1 and the integrated summary IS2 and a reason associated with the difference point (Step S3). For example, upon determining that there is the difference between the integrated summary IS1 during the time period T1 and the integrated summary IS2 during the time period T2, the information processing apparatus 100 extracts the difference point between the integrated summary IS1 and the integrated summary IS2 and the reason associated with the difference point.

On the other hand, upon determining that there is no difference between the integrated summary IS1 during the time period T1 and the integrated summary IS2 during the time period T2, the information processing apparatus 100 does not extract the difference point between the integrated summary IS1 and the integrated summary IS2 and the reason associated with the difference point.

As a more specific example, it is assumed that the integrated summary IS1 during the time period T1 is “the statement made by the accuser is not reliable”. It is also assumed that the integrated summary IS2 during the time period T2 is “a plurality of contents similar to the accused contents are testified. The defense of the accused party is weakening”. In this case, the information processing apparatus 100 uses a conventional technique such as a natural language processing technique to extract “the defense of the accused party is weakening” as the difference point and “a plurality of contents similar to the accused contents are testified” as the reason.

Subsequently, the information processing apparatus 100 provides the user U1 with information on the difference point and the reason (Step S4). For example, the information processing apparatus 100 provides the user with the information on the difference point indicating that “the defense of the accused party is weakening” and the reason indicating that “a plurality of contents similar to the accused contents are testified”.

Conventionally, there has been known a technique of providing a comment posted by a user on a news article to other users who have browsed the news article. However, in the above-described conventional technique, since the comment posted by the user on the news article is merely provided to other users who have browsed the news article, there is room for improvement in terms of providing useful information on the comment. Therefore, the information processing apparatus 100 provides the user with the difference point between the first integrated summary and the second integrated summary and the reason associated with the difference point on the basis of the first integrated summary generated during the first time period and the second integrated summary generated during the second time period. In this manner, the information processing apparatus 100 can provide useful information on the comment.

The information processing apparatus 100 can also provide a user with a change in the content of the integrated summary for a piece of news. As a result, even if the user knows such a piece of news halfway through, the user can grasp a change in the content of the previous integrated summary that the user knows. In addition, since the user can grasp the change in the content of the integrated summary, the user is less likely to be affected by biased information for a piece of news.

### [2. Configuration of Information Processing System]

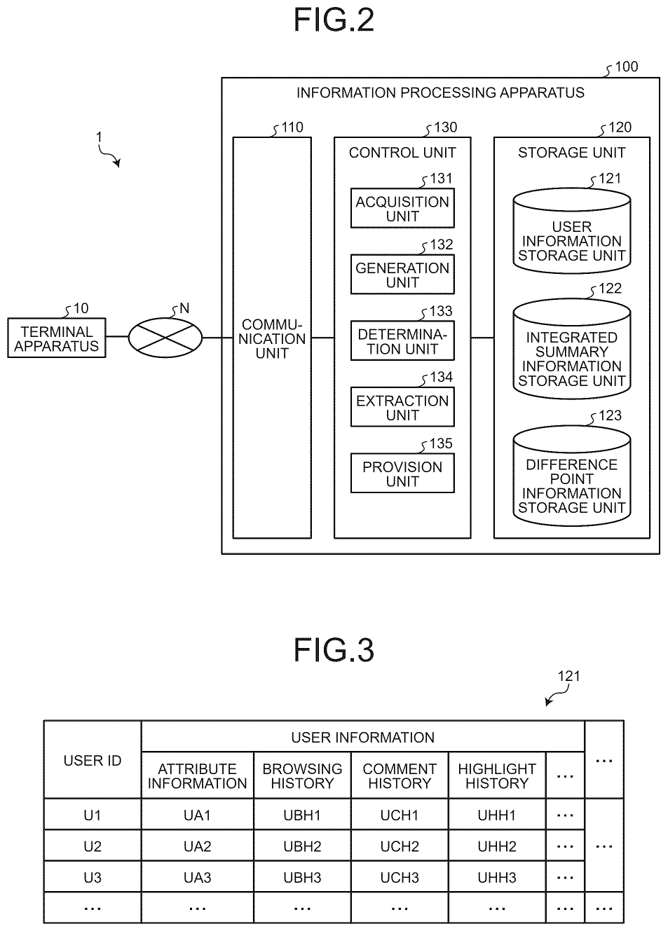

Next, a configuration of an information processing system 1 according to the embodiment will be described with reference to FIG. 2. FIG. 2 is a diagram illustrating a configuration example of the information processing system 1 according to the embodiment. As illustrated in FIG. 2, the information processing system 1 includes a terminal apparatus 10 and the information processing apparatus 100. The terminal apparatus 10 and the information processing apparatus 100 are connected to each other via a network N so as to be able to communicate with each other in a wired or wireless manner. It is noted that the information processing system 1 illustrated in FIG. 2 may include a plurality of terminal apparatuses 10 and a plurality of information processing apparatuses 100.

The terminal apparatus 10 is an information processing apparatus used by a user who accesses a content such as a web page or an application content displayed on a browser. For example, the terminal apparatus 10 is a desktop personal computer (PC), a notebook PC, a tablet terminal, a mobile phone, a personal digital assistant (PDA), or the like.

The information processing apparatus 100 is an information processing apparatus capable of communicating with various devices via the network N, and is realized by, for example, a server device, a cloud system, or the like. For example, the information processing apparatus 100 is connected to various other devices via the network N so as to be able to communicate therewith.

### [3. Configuration of Information Processing Apparatus]

Next, an example of a functional configuration of the information processing apparatus 100 will be described with reference to FIG. 2. As illustrated in FIG. 2, the information processing apparatus 100 includes a communication unit 110, a storage unit 120, and a control unit 130.

### (Regarding Communication Unit 110)

The communication unit 110 is realized by, for example, a network interface card (NIC) or the like. Then, the communication unit 110 is connected to the network N in a wired or wireless manner, and transmits and receives information to and from various other devices.

### (Regarding Storage Unit 120)

The storage unit 120 is realized by, for example, a semiconductor memory element such as a random access memory (RAM) or a flash memory, or a storage device such as a hard disk or an optical disk. In addition, the storage unit 120 includes a user information storage unit 121, an integrated summary information storage unit 122, and a difference point information storage unit 123.

### (Regarding User Information Storage Unit 121)

The user information storage unit 121 stores various types of information on the user. Here, FIG. 3 illustrates an example of the user information storage unit 121 according to the embodiment. In the example illustrated in FIG. 3, the user information storage unit 121 includes items such as a “user ID (identifier)”, “user information”, a “group ID”, and “interest information”. For example, the “user information” has items such as “attribute information”, a “browsing history”, a “comment history”, and a “highlight history”.

The “user ID” is an identifier for identifying the user. The “attribute information” is information on the attributes of the user associated with the “user ID”. For example, the attribute information is information on a demographic attribute, a psychographic attribute, or the like. For example, the demographic attribute is a demographic attribute. As a more specific example, the demographic attribute includes an age, a gender, an occupation, a place of residence, an annual income, a family composition, and the like. For example, the psychographic attribute is a psychological attribute. As a more specific example, the psychographic attribute includes a lifestyle, values, interests and concerns, and the like.

The “browser history” is information on a browsing history indicating a history of contents viewed by the user associated with the “user ID”. For example, the browsing history includes information on the contents viewed by the user, the date and time of browsing the contents, and the like.

The “comment history” is information on a comment history that indicates a history of comments posted by the user associated with the “user ID” on the content. For example, the comment history includes information on the date and time of posting the comment, the content to which the comment is posted, and the content of the posted comment.

The “highlight history” is information on a highlight history that indicates a history in which the user associated with the “user ID” has highlighted the content. For example, the highlight history includes information on the date and time when the highlight has been performed, the content where the highlight has been performed, and the like.

For example, in FIG. 3, “U1” identified by the user ID has attribute information of “UA1”, a browsing history of “UBH1”, a comment history of “UCH1”, and a highlight history of “UHH1”.

It is noted that in the example illustrated in FIG. 3, the attribute information and the like are expressed by an abstract code such as “UA1”, but the attribute information and the like may be a numerical value, a character string, or a file format of a file including various types of information indicating the attribute information.

### (Regarding Integrated Summary Information Storage Unit 122)

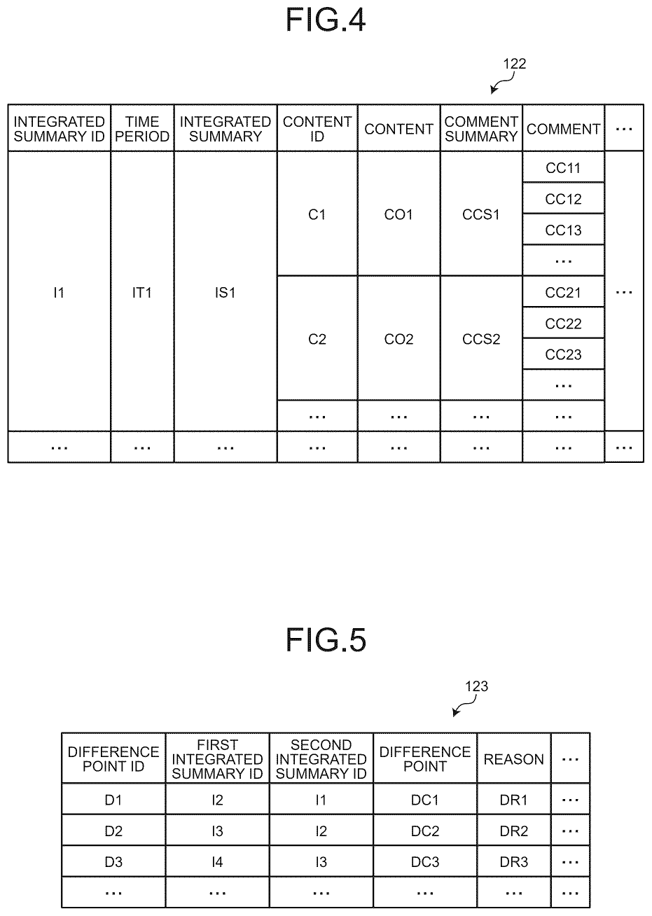

The integrated summary information storage unit 122 stores various types of information on the integrated summary. Here, FIG. 4 illustrates an example of the integrated summary information storage unit 122 according to the embodiment. In the example illustrated in FIG. 4, the integrated summary information storage unit 122 includes items such as an “integrated summary ID”, a “time period”, an “integrated summary”, a “content ID”, a “content”, a “comment summary”, and a “comment”.

The “integrated summary ID” is an identifier for identifying the integrated summary. The “time period” is information on a time period when the integrated summary associated with the “integrated summary ID” is generated. The “integrated summary” is information on the integrated summary associated with the “integrated summary ID”.

The “content ID” is an identifier for identifying a content corresponding to a comment summary used to generate the integrated summary associated with the “integrated summary ID”. The “content” is information on a content associated with the “content ID”. The “comment summary” is information on a comment summary generated on the basis of a plurality of comments on the content associated with the “content ID”. The “comment” is information on a comment posted on the content associated with the “content ID”.

For example, in FIG. 4, “I1” identified by the integrated summary ID is a time period of “IT1”, an integrated summary is “IS1”, a content ID is “C1”, a content is “CO1”, a comment summary is “CCS1”, and a comment is “CC11”.

It is noted that, in the example illustrated in FIG. 4, the time period or the like is expressed by an abstract code such as “IT1”, but the time period or the like may be a numerical value, a character string, or a file format of a file including various types of information indicating the time period.

### (Regarding Difference Point Information Storage Unit 123)

The difference point information storage unit 123 stores various types of information on difference points. Here, FIG. 5 illustrates an example of the difference point information storage unit 123 according to the embodiment. In the example illustrated in FIG. 5, the difference point information storage unit 123 includes items such as a “difference point ID”, a “first integrated summary ID”, a “second integrated summary ID”, a “difference point”, and a “reason”.

The “difference point ID” is an identifier for identifying a difference point. The “first integrated summary ID” is an identifier for identifying the integrated summary used to extract the difference point associated with the “difference point ID”. The “second integrated summary ID” is an identifier for identifying the integrated summary used to extract the difference point associated with the “difference point ID”.

The “difference point” is information on a difference point associated with the “difference point ID”. In the example of FIG. 5, the difference point is a difference point extracted on the basis of the integrated summary identified by the first integrated summary ID and the integrated summary identified by the second integrated summary ID.

The “reason” is information on a reason associated with the “difference point ID”. In the example of FIG. 5, the reason is a reason associated with the difference point extracted on the basis of the integrated summary identified by the first integrated summary ID and the integrated summary identified by the second integrated summary ID.

For example, in FIG. 5, “D1” identified by the difference point ID has the first integrated summary ID of “I2”, the second integrated summary ID of “I1”, the difference point of “DC1”, and the reason of “DR1”.

It is noted that, in the example illustrated in FIG. 5, the difference point or the like is expressed by an abstract code such as “DC1”, but the difference point may be a numerical value, a character string, or a file format of a file including various types of information indicating the difference point.

### (Regarding Control Unit 130)

The control unit 130 is a controller and is realized by, for example, allowing a central processing unit (CPU) or a micro processing unit (MPU) to execute various programs stored in a storage device inside the information processing apparatus 100 using a RAM as a working area. Furthermore, the control unit 130 is a controller and is realized by, for example, an integrated circuit such as an application specific integrated circuit (ASIC) or a field programmable gate array (FPGA).

As illustrated in FIG. 2, the control unit 130 has an acquisition unit 131, a generation unit 132, a determination unit 133, an extraction unit 134, and a provision unit 135, and realizes or executes a function and an action of information processing described below. It is noted that the internal configuration of the control unit 130 is not limited to the configuration illustrated in FIG. 2, and may have another configuration as long as the configuration performs information processing to be described below. Furthermore, a connection relationship between the respective processing units in the control unit 130 is not limited to a connection relationship illustrated in FIG. 2, and may be another connection relationship.

### (Regarding Acquisition Unit 131)

In the acquisition unit 131, specifically, the acquisition unit 131 acquires user information from the terminal apparatus 10, an external server having a database in which the user information is stored in advance, an external server that manages the news providing application A, and the like.

For example, the acquisition unit 131 acquires attribute information on the user as user information. The acquisition unit 131 acquires a browsing history of articles in the news providing application A. Furthermore, the acquisition unit 131 acquires a comment history and a highlight history as the user information. Then, the acquisition unit 131 stores the acquired user information such as the attribute information, the browsing history, the comment history, and the highlight history in the user information storage unit 121.

### (Regarding Generation Unit 132)

The generation unit 132 generates various types of information. Specifically, the generation unit 132 generates a comment summary on the basis of a plurality of comments on a content related to one event, in which the content is provided in a predetermined service. Then, the generation unit 132 stores information related to the generated comment summary in the integrated summary information storage unit 122.

Referring to the example in FIG. 1, the generation unit 132 generates the comment summary CS11 on the basis of a plurality of comments posted for the article AR11. Further, the generation unit 132 also generates the comment summary CS12 on the basis of a plurality of comments posted for the article AR12. Further, the generation unit 132 also generates the comment summary CS13 on the basis of a plurality of comments posted for the article AR13. Then, the generation unit 132 stores information on the generated comment summaries CS11 to CS13 in the integrated summary information storage unit 122.

Further, the generation unit 132 also generates the comment summary CS21 on the basis of a plurality of comments posted for the article AR21. Further, the generation unit 132 also generates the comment summary CS22 on the basis of a plurality of comments posted for the article AR22. Further, the generation unit 132 also generates the comment summary CS23 on the basis of a plurality of comments posted for the article AR23. Then, the generation unit 132 stores information on the generated comment summaries CS21 to CS23 in the integrated summary information storage unit 122.

Furthermore, the generation unit 132 generates an integrated summary for one event for each predetermined time period on the basis of a comment summary generated on the basis of a plurality of comments on a content related to one event, in which the content is provided in a predetermined service. Then, the generation unit 132 then stores information on the generated integrated summary in the integrated summary information storage unit 122.

For example, the generation unit 132 generates, at a predetermined timing, an integrated summary for a piece of news, in which the integrated summary is provided during a predetermined time period. In this case, when the number of comment summaries having a common content among the comment summaries for each content related to a piece of news is equal to or greater than a predetermined threshold value, the generation unit 132 generates the integrated summary on the basis of the comment summaries having the common content.

As a more specific example, it is assumed that a piece of news is news related to an indictment. In addition, it is assumed that the tendency of a content of a comment summary for each article provided during the first time period is a content indicating that “the statement made by the accuser is not reliable”. Moreover, it is assumed that the tendency of a content of a comment summary for each article provided during the second time period is a content indicating that “a plurality of contents similar to the accused contents are testified. The defense of the accused party is weakening”. In this case, the generation unit 132 generates, as a first integrated summary, an integrated summary stating that “the statement made by the accuser is not reliable” on the basis of the comment summary for each article during the first time period. Further, the generation unit 132 generates, as a second integrated summary, an integrated summary stating that “a plurality of contents similar to the accused contents are testified. The defense of the accused party is weakening” on the basis of the comment summary for each article during the second time period. Then, the generation unit 132 stores information on the generated first and second integrated summaries in the integrated summary information storage unit 122.

### (Regarding Determination Unit 133)

The determination unit 133 determines whether there is a difference between the first integrated summary generated by the generation unit 132 during the first time period and the second integrated summary generated by the generation unit 132 during the second time period. That is, the determination unit 133 determines whether there is a difference between the content of the first integrated summary during the first time period and the content of the second integrated summary during the second time period.

For example, upon determining that the difference between the first integrated summary during the first time period and the second integrated summary during the second time period is equal to or greater than a predetermined threshold value, the determination unit 133 determines that there is the difference between the first integrated summary during the first time period and the second integrated summary during the second time period.

As a more specific example, it is assumed that the first integrated summary during the first time period is “the statement made by the accuser is not reliable”. Further, it is assumed that the second integrated summary during the second time period is “a plurality of contents similar to the accused contents are testified. The defense of the accused party is weakening”. In this case, the determination unit 133 uses a conventional technique such as a natural language processing technique to determine the difference between the first integrated summary during the first time period and the second integrated summary during the second time period. At this time, the determination unit 133 compares the first integrated summary stating that “the statement made by the accuser is not reliable” with the second integrated summary stating that “a plurality of contents similar to the accused contents are testified. The defense of the accused party is weakening” and determines that there is the difference between the first integrated summary and the second integrated summary.

On the other hand, upon determining that the difference between the integrated summary IS1 during the time period T1 and the integrated summary IS2 during the time period T2 is less than the predetermined threshold value, the determination unit 133 determines that there is no difference between the integrated summary IS1 during the time period T1 and the integrated summary IS2 during the time period T2.

As a more specific example, it is assumed that the first integrated summary during the first time period is “the statement made by the accuser is not reliable”. Furthermore, it is assumed that the second integrated summary during the second time period is “a plurality of contents completely opposite to the accused contents are testified. The statement made by the accuser is becoming further unreliable”. In this case, the determination unit 133 uses a conventional technique such as a natural language processing technique to determine the difference between the first integrated summary during the first time period and the second integrated summary during the second time period. At this time, the determination unit 133 compares the first integrated summary stating that “the statement made by the accuser is not reliable” with the second integrated summary stating that “a plurality of contents completely opposite to the accused contents are testified. The statement made by the accuser is becoming further unreliable” and determines that there is no difference between the first integrated summary and the second integrated summary.

### (Regarding Extraction Unit 134)

The extraction unit 134 extracts a difference point between the first integrated summary and the second integrated summary and a reason associated with the difference point on the basis of the first integrated summary generated by the generation unit 132 during the first time period and the second integrated summary generated by the generation unit 132 during the second time period.

For example, when a determination result determined by the determination unit 133 satisfies a predetermined condition, the extraction unit 134 extracts the difference point between the first integrated summary and the second integrated summary and the reason. For example, a case in which the determination result satisfies the predetermined condition is assumed as a case in which the determination unit 133 determines that there is the difference between the first integrated summary during the first time period and the second integrated summary during the second time period. In this case, when the determination unit 133 determines that there is the difference between the first integrated summary during the first time period and the second integrated summary during the second time period, the extraction unit 134 extracts the difference point between the first integrated summary and the second integrated summary and the reason. Then, the extraction unit 134 stores the extracted difference point and reason in the difference point information storage unit 123.

As a more specific example, it is assumed that the first integrated summary during the first time period is “the statement made by the accuser is not reliable”. Further, it is assumed that the second integrated summary during the second time period is “a plurality of contents similar to the accused contents are testified. The defense of the accused party is weakening”. In this case, the extraction unit 134 uses a conventional technique such as a natural language processing technique to extract “the defense of the accused party is weakening” as a difference point and “a plurality of contents similar to the accused contents are testified” as a reason. The extraction unit 134 then stores, in the difference point information storage unit 123, the extracted difference point indicating that “the defense of the accused party is weakening” and the extracted reason indicating that “a plurality of contents similar to the accused contents are testified”.

Furthermore, a case in which the determination result does not satisfy the predetermined condition is assumed as a case in which the determination unit 133 determines that there is no difference between the first integrated summary during the first time period and the second integrated summary during the second time period. In this case, when the determination unit 133 determines that there is no difference between the first integrated summary during the first time period and the second integrated summary during the second time period, the extraction unit 134 does not extract the difference point and the reason between the first integrated summary and the second integrated summary.

As a more specific example, it is assumed that the first integrated summary during the first time period is “the statement made by the accuser is not reliable”. Furthermore, it is assumed that the second integrated summary during the second time period is “a plurality of contents completely opposite to the accused contents are testified. The statement made by the accuser is becoming further unreliable”. In this case, the extraction unit 134 does not extract the difference point and the reason using the conventional technique such as the natural language processing technique.

### (Regarding Provision Unit 135)

The provision unit 135 provides various types of information. Specifically, the provision unit 135 provides information on the difference point and the reason to a user who uses a predetermined service. For example, the provision unit 135 provides, to the user, information on the difference point indicating that “the defense of the accused party is weakening” and information on the reason indicating that “a plurality of contents similar to the accused contents are testified”, which are stored in the difference point information storage unit 123.

### [4. Processing Procedures (1)]

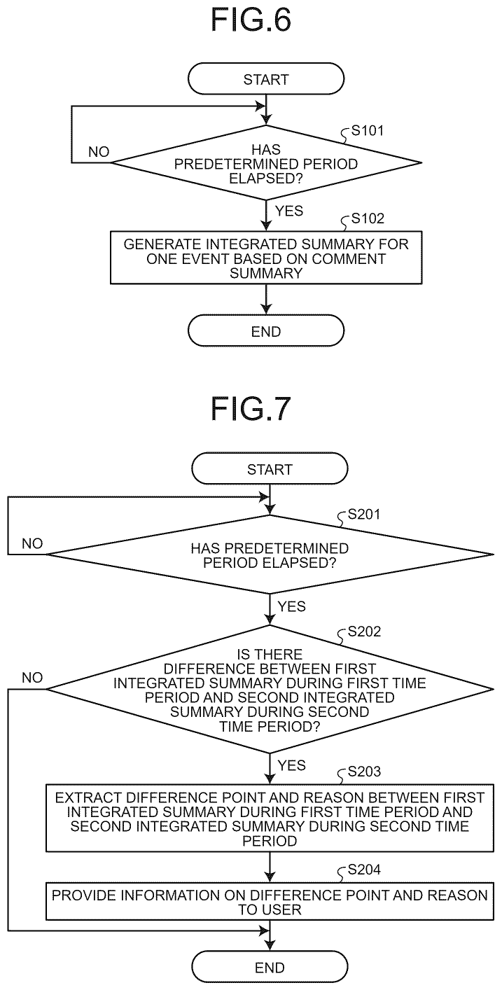

Next, procedures of generation processing executed by the information processing apparatus 100 according to the embodiment will be described with reference to FIG. 6. FIG. 6 is a flowchart illustrating an example of a flow of the generation processing executed by the information processing apparatus 100 according to the embodiment.

As illustrated in FIG. 6, the generation unit 132 determines whether a predetermined period has elapsed (Step S101). Specifically, when the predetermined period has not elapsed (Step S101; No), the generation unit 132 waits until the predetermined period has elapsed. The predetermined period used herein is, for example, a period between the first time period and the second time period.

On the other hand, when the predetermined period has elapsed (Step S101; Yes), the generation unit 132 generates an integrated summary for one event on the basis of the comment summary (Step S102). In this manner, the generation unit 132 generates the integrated summary of one event for each time period.

### [5. Processing Procedures (2)]

Next, the procedures of provision processing executed by the information processing apparatus 100 according to the embodiment will be described with reference to FIG. 7. FIG. 7 is a flowchart illustrating an example of a flow of provision processing executed by the information processing apparatus 100 according to the embodiment.

As illustrated in FIG. 7, the determination unit 133 determines whether a predetermined period has elapsed (Step S201). Specifically, when the predetermined period has not elapsed (Step S201; No), the determination unit 133 waits until the predetermined period has elapsed.

On the other hand, when the predetermined period has elapsed (Step S201; Yes), the determination unit 133 determines whether there is a difference between the first integrated summary during the first time period and the second integrated summary during the second time period (Step S202).

Specifically, upon determining that the difference between the first integrated summary during the first time period and the second integrated summary during the second time period is equal to or greater than a predetermined threshold value (Step S202; Yes), the determination unit 133 determines that there is the difference between the first integrated summary during the first time period and the second integrated summary during the second time period.

Then, the extraction unit 134 extracts a difference point and a reason between the first integrated summary during the first time period and the second integrated summary during the second time period (Step S203). Next, the provision unit 135 provides the user with information on the difference point and the reason (Step S204).

On the other hand, upon determining that the difference between the first integrated summary during the first time period and the second integrated summary during the second time period is less than the predetermined threshold value (Step S202; No), the determination unit 133 determines that there is no difference between the first integrated summary during the first time period and the second integrated summary during the second time period. Then, the information processing apparatus 100 ends the information processing.

### [6. Modifications]

The information processing apparatus 100 described above may be implemented in various different forms other than the above embodiments. Therefore, another embodiment of the information processing apparatus 100 will be described below.

### [6-1. Content]

In the embodiment, an article has been described as an example of a content, but the content is not limited thereto. For example, the content may be a content in which information on a product or a service provided by an Internet shopping service is arranged, a content in which information on a place or a store provided by a map information providing service is arranged, or the like.

### [6-2. Other Application Examples]

In the embodiment, the news providing service has been described as an example of the predetermined service, but the predetermined service may not be limited thereto, and the predetermined service may be any service. For example, the predetermined service may be an Internet shopping service.

For example, the generation unit 132 may generate an integrated summary for one product or one service on the basis of a comment summary generated on the basis of a plurality of comments on one product or one service traded in the Internet shopping service. For example, the generation unit 132 may generate an integrated summary for one product or one service, which is an integrated summary during a predetermined time period, at a predetermined timing.

As a more specific example, it is assumed that the comment is a review. In addition, it is assumed that the review is posted by a user for a product or a service traded on the Internet shopping service. In this case, the generation unit 132 may generate an integrated summary for the product or the service every predetermined time period on the basis of the comment summary generated on the basis of a plurality of reviews for the product or the service.

As a result, since the generation unit 132 generates the integrated summary for one product or one service on the basis of the comment summary generated on the basis of a plurality of comments on one product or one service, thereby making it possible to generate an appropriate integrated summary for one product or one service.

The predetermined service may also be a map information providing service. For example, the generation unit 132 may generate an integrated summary for one place or one store on the basis of a comment summary generated on the basis of a plurality of comments for one place or one store provided by a predetermined map information providing service. For example, the generation unit 132 may generate the integrated summary for one place or one store at a predetermined timing, in which the integrated summary is provided during a predetermined time period.

As a more specific example, it is assumed that a comment is word of mouth. It is also assumed that a user has posted a word-of-mouth review about a place or a store provided by the map information service. In this case, the generation unit 132 may generate an integrated summary for such a place or a store for each predetermined time period on the basis of a comment summary generated on the basis of a plurality of word-of-mouth reviews about the place or the store.

Accordingly, since the generation unit 132 generates the integrated summary for one place or one store on the basis of the comment summary generated on the basis of a plurality of comments for one place or one store, thereby making it possible to generate an appropriate integrated summary for one place or one store.

### [6-3. Integrated Summary]

In the embodiment, a description has been given as an example in which the generation unit 132 generates the integrated summary on the basis of the comment summaries having a common content when the number of comment summaries having the common content is equal to or greater than the predetermined threshold value, but the present is not limited thereto. For example, the acquisition unit 131 acquires attribute information on the user from the user information storage unit 121. Then, when the number of comment summaries having a common content among the comment summaries for the respective groups formed of a plurality of users having the same or similar ages indicated by the attribute information acquired by the acquisition unit 131 is equal to or greater than a predetermined threshold value, the generation unit 132 may generate the integrated summary on the basis of the comment summaries having the common content.

As a more specific example, the acquisition unit 131 acquires the attribute information on the user and other users from the user information storage unit 121. In this case, first, when an age indicated by the attribute information on the user and an age indicated by the attribute information on the other users are within a predetermined range, the generation unit 132 determines that the user and the other users belong to a group in which the ages are the same or similar. Subsequently, the generation unit 132 generates a group including the same or similar plurality of users and having a predetermined number of users.

Then, when the number of comments having a common content among a plurality of comments posted by a plurality of users belonging to the group is equal to or greater than a predetermined threshold value, the generation unit 132 generates a comment summary on the basis of the comments having the common content. In this manner, the generation unit 132 generates the comment summary for each group. Then, when the number of comment summaries having a common content among the comment summaries is equal to or greater than the predetermined threshold value, the generation unit 132 may generate an integrated summary on the basis of the comment summaries having the common content.

As a result, the integrated summary is generated on the basis of a comment summary in which the number of comments having a common content among the comment summaries for the respective groups formed of a plurality of users having the same age or similar age is equal to or greater than a predetermined threshold value, thereby enabling the generation unit 132 to generate an appropriate integrated summary.

In addition, the acquisition unit 131 acquires the attribute information on the user from the user information storage unit 121. Then, when the number of comment summaries having a common content among the comment summaries for each content related to one event, which are generated on the basis of a plurality of comments posted by a plurality of users having the same gender indicated by the attribute information acquired by the acquisition unit 131, is equal to or greater than a predetermined threshold value, the generation unit 132 may generate the integrated summary on the basis of the comment summaries having a common content.

As a more specific example, it is assumed that the gender of the user is male and the gender of the other user is male. In this case, the acquisition unit 131 acquires the attribute information on the user and the other user from the user information storage unit 121. Subsequently, since the gender indicated by the attribute information on the user is male and the gender indicated by the attribute information on the other user is male, the generation unit 132 determines that the user and the other user have the same gender.

Then, the generation unit 132 generates a comment summary for each content related to one event on the basis of a plurality of comments posted by a plurality of users of the same gender. Then, when the number of comment summaries having a common content among the comment summaries is equal to or greater than the predetermined threshold value, the generation unit 132 may generate an integrated summary on the basis of the comment summaries having the common content.

As a result, when the number of comment summaries having a common content among the comment summaries for each content related to one event, in which the comment summaries are generated on the basis of a plurality of comments posted by a plurality of users having the same gender, is equal to or greater than a predetermined threshold value, the generation unit 132 generates an integrated summary on the basis of the comment summaries having the common content, thereby making it possible to generate an appropriate integrated summary.

### [6-4. Provision Mode]

Furthermore, the information on the difference point and the reason provided by the provision unit 135 may be provided by any provision mode. For example, the information on the difference point and the reason may be provided to a user when a predetermined service is used.

Furthermore, the provision unit 135 may provide the user with information in which the integrated summary during the respective time periods is listed together with the information on the difference point and the reason. For example, the provision unit 135 may list information in which a time period is associated with an integrated summary of the time period, and may provide the listed information to the user together with the information on the difference point and the reason.

### [6-5. Program]

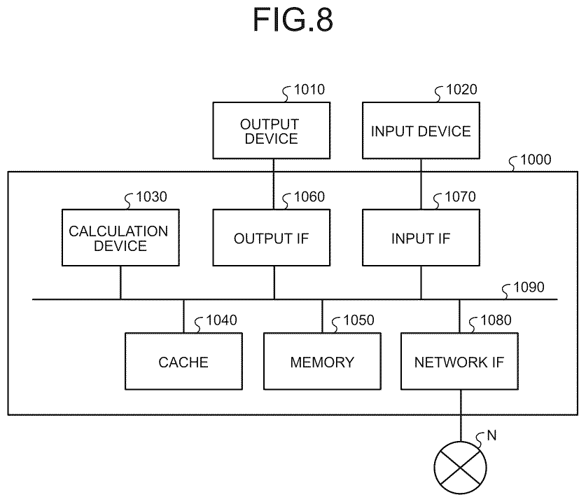

Furthermore, the information processing apparatus 100 according to the above-described embodiment is realized by, for example, a computer 1000 having a configuration as illustrated in FIG. 8. FIG. 8 is a diagram illustrating an example of a hardware configuration. The computer 1000 is connected to an output device 1010 and an input device 1020, and has a configuration in which a calculation device 1030, a cache 1040, a memory 1050, an output interface (IF) 1060, an input IF 1070, and a network IF 1080 are connected to each other by a bus 1090.

The calculation device 1030 is operated on the basis of a program stored in the cache 1040 or the memory 1050 or a program read from the input device 1020, and executes various types of processing. The cache 1040 is a memory device that temporarily stores data used by the calculation device 1030 for various types of calculation, such as a RAM. Furthermore, the memory 1050 is a storage device in which data used by the calculation device 1030 for various types of calculation and various databases are registered, and is realized by a read only memory (ROM), a hard disk drive (HDD), a flash memory, and the like.

The output IF 1060 is an interface for transmitting information to be output to the output device 1010 that outputs various types of information, such as a monitor or a printer, and is realized by, for example, connectors of standards, such as a universal serial Bus (USB), a digital visual interface (DVI), or a high definition multimedia interface (HDMI (registered trademark)). Furthermore, the input IF 1070 is an interface for receiving information from various input devices 1020 such as a mouse, a keyboard, and a scanner, and is realized by, for example, a USB or the like.

It is noted that the input device 1020 may be, for example, a device that reads information from an optical recording medium such as a compact disc (CD), a digital versatile disc (DVD), or a phase change rewritable disc (PD), a magneto-optical recording medium such as a magneto-optical disk (MO), a tape medium, a magnetic recording medium, a semiconductor memory, or the like. Furthermore, the input device 1020 may be an external storage medium such as a USB memory.

The network IF 1080 receives data from another device via the network N and transmits the data to the calculation device 1030, and transmits data generated by the calculation device 1030 to another device via the network N.

The calculation device 1030 controls the output device 1010 and the input device 1020 via the output IF 1060 and the input IF 1070. For example, the calculation device 1030 loads a program from the input device 1020 or the memory 1050 onto the cache 1040 and executes the loaded program.

For example, in a case where the computer 1000 functions as the information processing apparatus 100, the calculation device 1030 of the computer 1000 realizes the function of the control unit 130 by executing the program loaded on the cache 1040.

### [6-6. Others]

In addition, among the processes described in the above embodiment and modifications, all or a part of the processes described as being automatically performed can be manually performed, or all or a part of the processes described as being manually performed can be automatically performed by a known method. In addition, the processing procedure, specific name, and information including various types of data and parameters illustrated in the document and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in any unit according to various loads, usage conditions, and the like.

In addition, the above-described embodiments and modifications can be appropriately combined within a range in which processing contents do not contradict each other.

In addition, the “unit (section, module, unit)” described above can be read as “means”, “circuit”, or the like. For example, the provision unit can be replaced with a provision means or a provision circuit.

### [7. Effects]

As described above, the information processing apparatus 100 according to the embodiment includes the generation unit 132, the extraction unit 134, and the provision unit 135. The generation unit 132 generates an integrated summary for one event for each predetermined time period on the basis of a comment summary which is a summary of a plurality of comments generated on the basis of a plurality of comments on a content regarding one event, in which the content is provided on a predetermined service. The extraction unit 134 extracts a difference point between the first integrated summary and the second integrated summary and a reason associated with the difference point on the basis of the first integrated summary generated by the generation unit 132 during the first time period and the second integrated summary generated by the generation unit 132 during the second time period. The provision unit 135 provides information on a difference point and a reason to a user who uses a predetermined service.

Since the information processing apparatus 100 according to the embodiment provides the user with information on a difference point between the first integrated summary and the second integrated summary and the reason, it is possible to provide useful information on the comment.

Furthermore, in the information processing apparatus 100 according to the embodiment, the generation unit 132 generates the integrated summary on the basis of the first comment summary generated on the basis of a plurality of comments on the first content related to one event and the second comment summary generated on the basis of a plurality of comments on the second content related to one event.

As a result, the information processing apparatus 100 according to the embodiment generates the integrated summary on the basis of the first comment summary and the second comment summary, thereby making it possible to generate an appropriate integrated summary.

Furthermore, in the information processing apparatus 100 according to the embodiment, when the number of comment summaries having a common content among the comment summaries for the respective contents related to one event is equal to or greater than a predetermined threshold value, the generation unit 132 generates the integrated summary on the basis of the comment summaries having the common content.

As a result, when the number of comment summaries having the common content is equal to or greater than the predetermined threshold value, the information processing apparatus 100 according to the embodiment generates the integrated summary on the basis of the comment summary having the common content, thereby making it possible to generate an appropriate integrated summary.

Furthermore, the information processing apparatus 100 according to the embodiment further includes the acquisition unit 131 configured to acquire attribute information on the user from the user, in which the generation unit 132 is configured to generate, when the number of comment summaries having a common content among the comment summaries for each group formed of a plurality of users having the same or similar ages indicated by the attribute information is equal to or greater than a predetermined threshold value, the integrated summary on the basis of the comment summary having the common content.

As a result, the information processing apparatus 100 according to the embodiment generates the integrated summary on the basis of the comment summary having the common content when the number of comment summaries having the common content among the comment summaries for each group formed of a plurality of users having the same or similar ages is equal to or greater than the predetermined threshold value, thereby making it possible to generate an appropriate integrated summary.

Furthermore, the information processing apparatus 100 according to the embodiment further includes the acquisition unit 131 configured to acquire attribute information on the user from the user, in which the generation unit 132 is configured to generate, when the number of comment summaries having a common content among the comment summaries for each content related to one event, the comment summaries being generated on the basis of a plurality of comments posted by a plurality of users having the same gender indicated by the attribute information, is equal to or greater than a predetermined threshold value, the integrated summary based on the comment summaries having the common content.

As a result, the information processing apparatus 100 according to the embodiment generates the integrated summary on the basis of the comment summaries having the common content when the number of comment summaries having the common content among the comment summaries for each content related to one event, the comment summaries being generated on the basis of the plurality of comments posted by the plurality of users having the same gender, is equal to or greater than the predetermined threshold value, thereby making it possible to generate an appropriate integrated summary.

Furthermore, the information processing apparatus 100 according to the embodiment further includes the determination unit 133 configured to determine presence or absence of a difference between the first integrated summary generated by the generation unit 132 during the first time period and the second integrated summary generated by the generation unit 132 during the second integrated period, in which the extraction unit 134 is configured to extract the difference point and the reason when a determination result determined by the determination unit 133 satisfies a predetermined condition.

As a result, when the determination result satisfies the predetermined condition, the information processing apparatus 100 according to the embodiment extracts the difference point and the reason, thereby making it possible to provide the difference point that gives the user a sense of satisfaction.

Furthermore, in the information processing apparatus 100 according to the embodiment, when the determination unit 133 determines that the difference between the first integrated summary and the second integrated summary is equal to or greater than a predetermined threshold value, the extraction unit 134 extracts the difference point and the reason.

As a result, when it is determined that the difference between the first integrated summary and the second integrated summary is equal to or greater than the predetermined threshold value, the information processing apparatus 100 according to the embodiment extracts the difference point and the reason, thereby making it possible to provide the difference point that gives the user a sense of satisfaction.

Furthermore, in the information processing apparatus 100 according to the embodiment, when the determination unit 133 determines that the difference between the first integrated summary and the second integrated summary is less than a predetermined threshold value, the extraction unit 134 does not extract the difference point and the reason.

As a result, when it is determined that the difference between the first integrated summary and the second integrated summary is less than the predetermined threshold value, the information processing apparatus 100 according to the embodiment does not extract the difference point and the reason, thereby making it possible to reduce provision of the difference point that does not give the user a sense of satisfaction.

Furthermore, in the information processing apparatus 100 according to the embodiment, the generation unit 132 is configured to generate the integrated summary of a piece of news on the basis of a comment summary generated on the basis of a plurality of comments on a content related to the piece of news, in which the content is provided on a predetermined news providing service as a predetermined service.

As a result, the information processing apparatus 100 according to the embodiment generates the integrated summary for a piece of news on the basis of the comment summary generated on the basis of the plurality of comments on the content related to the piece of news, thereby making it possible to generate an appropriate integrated summary for a piece of news.

Furthermore, in the information processing apparatus 100 according to the embodiment, the generation unit 132 is configured to generate the integrated summary for a single product or a single service on the basis of a comment summary generated on the basis of a plurality of comments for the single product or the single service traded on a predetermined Internet shopping service as a predetermined service.

As a result, the information processing apparatus 100 according to the embodiment generates the integrated summary for a single product or a single service on the basis of the comment summary generated on the basis of a plurality of comments on the single product or the single service, thereby making it possible to generate an appropriate integrated summary for a single product or a single service.

Furthermore, in the information processing apparatus 100 according to the embodiment, the generation unit 132 is configured to generate the integrated summary for a single place or a single store on the basis of a comment summary generated on the basis of a plurality of comments for the single place or the single store provided on a predetermined map information providing service as a predetermined service.

As a result, the information processing apparatus 100 according to the embodiment generates the integrated summary for a single place or a single store on the basis of the comment summary generated on the basis of a plurality of comments for the single place or the single store, thereby making it possible to generate an appropriate integrated summary for a single place or a single store.

Although some of the embodiments of the present application have been described in detail with reference to the drawings, these are merely examples, and the present invention can be implemented in other forms subjected to various modifications and improvements based on the knowledge of those skilled in the art, including the aspects described in the disclosure of the invention.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a generation unit configured to generate, based on a comment summary serving as a summary of a plurality of comments generated based on a plurality of comments on a content related to one event, the content being provided on a predetermined service, an integrated summary for the one event for each predetermined time period;
an extraction unit configured to extract, based on a first integrated summary generated by the generation unit during a first time period and a second integrated summary generated by the generation unit during a second time period, a difference point between the first integrated summary and the second integrated summary and a reason related to the difference point; and
a provision unit configured to provide information on the difference point and the reason to a user using the predetermined service.

2. The information processing apparatus according to claim 1, wherein the generation unit is configured to generate the integrated summary based on a first comment summary generated based on a plurality of comments on a first content related to the one event and a second comment summary generated based on a plurality of comments on a second content related to the one event.

3. The information processing apparatus according to claim 1, wherein the generation unit is configured to generate, when the number of comment summaries having a common content among the comment summaries for each content related to the one event is equal to or greater than a predetermined threshold value, the integrated summary based on the comment summaries having the common content.

4. The information processing apparatus according to claim 1, further comprising an acquisition unit configured to acquire attribute information on the user from the user,
wherein the generation unit is configured to generate, when the number of comment summaries having a common content among the comment summaries for each group formed of a plurality of users having the same or similar age indicated by the attribute information is equal to or greater than a predetermined threshold value, the integrated summary based on the comment summaries having the common content.

5. The information processing apparatus according to claim 1, further comprising an acquisition unit configured to acquire attribute information on the user from the user,
wherein the generation unit is configured to generate, when the number of comment summaries having a common content among the comment summaries for each content related to the one event, the comment summaries being generated based on a plurality of comments posted by a plurality of users having the same gender indicated by the attribute information, is equal to or greater than a predetermined threshold value, the integrated summary based on the comment summaries having the common content.

6. The information processing apparatus according to claim 1, further comprising a determination unit configured to determine presence or absence of a difference between the first integrated summary generated by the generation unit during the first time period and the second integrated summary generated by the generation unit during the second time period,
wherein the extraction unit is configured to extract, when a determination result determined by the determination unit satisfies a predetermined condition, the difference point and the reason.

7. The information processing apparatus according to claim 6, wherein the extraction unit is configured to extract, when the determination unit determines that the difference between the first integrated summary and the second integrated summary is equal to or greater than a predetermined threshold value, the difference point and the reason.

8. The information processing apparatus according to claim 6, wherein the extraction unit is configured not to extract, when the determination unit determines that the difference between the first integrated summary and the second integrated summary is less than a predetermined threshold value, the difference point and the reason.

9. The information processing apparatus according to claim 1, wherein the generation unit is configured to generate, based on a comment summary generated based on a plurality of comments on a content related to a piece of news, the content being provided on a predetermined news providing service as the predetermined service, the integrated summary for the piece of news.

10. The information processing apparatus according to claim 1, wherein the generation unit is configured to generate, based on a comment summary generated based on a plurality of comments on a single product or a single service traded on a predetermined Internet shopping service as the predetermined service, the integrated summary for the single product or the single service.

11. The information processing apparatus according to claim 1, wherein the generation unit is configured to generate, based on a comment summary generated based on a plurality of comments on a single place or a single store provided on a predetermined map information providing service as the predetermined service, the integrated summary for the single place or the single store.

12. An information processing method executed by a computer, the information processing method comprising the steps of:
generating, based on a comment summary serving as a summary of a plurality of comments generated based on a plurality of comments on a content related to one event, the content being provided on a predetermined service, an integrated summary for the one event for each predetermined time period;
extracting, based on a first integrated summary generated by the generation step during a first time period and a second integrated summary generated by the generation step during a second time period, a difference point between the first integrated summary and the second integrated summary and a reason related to the difference point; and
providing information on the difference point and the reason to a user using the predetermined service.

13. A non-transitory computer-readable recording medium having stored therein an information processing program for causing a computer to execute the procedures of:
generating, based on a comment summary serving as a summary of a plurality of comments generated based on a plurality of comments on a content related to one event, the content being provided on a predetermined service, an integrated summary for the one event for each predetermined time period;
extracting, based on a first integrated summary generated by the generation procedure during a first time period and a second integrated summary generated by the generation procedure during a second time period, a difference point between the first integrated summary and the second integrated summary and a reason related to the difference point; and
providing information on the difference point and the reason to a user using the predetermined service.
